(19) United States
(12) Patent Application Publication
(10) Pub. No.: US 2014/0211944 A1
(43) Pub. Date: Jul. 31, 2014

(54) SYSTEM AND METHOD OF PROTECTING, STORING AND DECRYPTING KEYS OVER A COMPUTERIZED NETWORK

(71) Applicant: Daniel Joseph Lutz, Los Angeles, CA (US)

(72) Inventors: Jerry Hayward, American Fork, UT (US); Daniel Joseph Lutz, Los Angeles, CA (US)

(73) Assignee: Daniel Joseph Lutz, Los Angeles, CA (US)

(21) Appl. No.: 14/035,688

(22) Filed: Sep. 24, 2013

Related U.S. Application Data
(60) Provisional application No. 61/705,023, filed on Sep. 24, 2012.

(51) Int. Cl. H04L 9/08

(52) U.S. Cl. CPC H04L 9/0822
USPC 380/281

(57) ABSTRACT

A system and method of protecting, decrypting, and storing encryption keys. An encryption escrow module stores a library of indexed encryption algorithms. A keychain storage module includes a plurality of encrypted keys and/or keychains that are encrypted according to varying encryption algorithms of the encryption escrow module. Biometrics are used to index encrypted keychains to specific algorithms, but the two are kept separate. Since a naked key is never stored and only produced in cooperation with a specific user, the keychain storage module and the encryption escrow module, cracking attempts that compromise only two of the three groups are unable to generate any naked keys.

### CROSS-REFERENCE TO RELATED APPLICATIONS

This invention claims priority, under 35 U.S.C. §120, to the U.S. Provisional Patent Application No. 61/705,023 by Jerry Hayward and Daniel Joseph Lutz filed on 24 Sep. 2012, which is incorporated by reference herein.

### BACKGROUND OF THE INVENTION

1. Field of the Invention

The present invention relates to systems and method of protecting, storing and decrypting keys, specifically to systems and methods of protecting, storing and decrypting keys over a computerized network.

2. Description of the Related Art

In the related art, it has been known to use encryption keys (keys) to encrypt and/or decrypt information and/or to act as an access requirement to electronic and/or computerized systems. One common type of key-based encryption is public-key cryptography, also known as asymmetric cryptography. Such a system requires two separate keys, one public and one private. The public key is able to be used to encrypt information and to verify digital signatures made by the private key, while the private key is able to generate valid digital signatures and decrypt information encrypted by the public key. With symmetric cryptography, the same key is used to both encrypt and to decrypt.

Vulnerabilities in encryption systems may be address by having longer keys that are more difficult to guess or calculate. However, if a third party is able to gain access to a key, especially a private key or symmetric key, they have a major advantage in being able to crack an encryption scheme, no matter how long the key may be. Accordingly, “man in the middle” attacks are a major concern. In a “man in the middle” attack, communication is observed between communicating parties and sometimes even altered. The parties are generally not aware of the “man in the middle” and over time, the “man in the middle” is able to glean critical information about the communication and sometimes even able to intercept key exchanges. Since much of the world's data communication occurs over the internet, “man in the middle” attacks are a real possibility for many communicating parties.

Additionally, private keys and symmetric keys must be accessible and available for parties to use when needed and therefore must be stored in some form. Storage of keys presents an additional concern, wherein third parties may be able to gain access to a key or even a storage facility full of keys associated with different accounts. Access to a set of keys associated with an account generally means access to anything and/or everything associated with that account. Accordingly, protecting sets of keys (keychains) and related information is important.

Some improvements have been made in the field. There are trusted third parties who issue electronic certificates verifying the identity of a user of a system. These certificates are used in various ways, including certification systems being embedded in web browsers. Further, hardware encryption tools may be used wherein a physical token having electronics that is associated with an encryption scheme may be used. Such tools generally include a key-cycling algorithm wherein particular keys are only valid for a short period of time. When access is needed, the user accesses the physical token, which then provides the current valid key string. The user then enters that key string into an associated decryption and/or access system before that particular key string expires and is then granted access.

Examples of references related to the present invention are described below in their own words, and the supporting teachings of each reference are incorporated by reference herein:

U.S. Pat. No. 8,214,650, issued to Dickinson et al., discloses a system for performing authentication of a first user to a second user includes the ability for the first user to submit multiple instances of authentication data which are evaluated and then used to generate an overall level of confidence in the claimed identity of the first user. The individual authentication instances are evaluated based upon: the degree of match between the user provided by the first user during the authentication and the data provided by the first user during his enrollment; the inherent reliability of the authentication technique being used; the circumstances surrounding the generation of the authentication data by the first user; and the circumstances surrounding the generation of the enrollment data by the first user. This confidence level is compared with a required trust level which is based at least in part upon the requirements of the second user, and the authentication result is based upon this comparison.

U.S. Pat. No. 7,089,214, issued to Wang, discloses a method permits a user to conduct a charged transaction utilizing a charge terminal of an electronic transaction system, the charge card terminal being configured to interface with a charge card for the purpose of conducting the charge card transaction. A merchant card is provided to a merchant where the charge card transaction is to be conducted. A charge card terminal at the merchant accepts the merchant card and a pin number or cellular phone number from the user conducting the charge card transaction. The phone number or pin number of the customer causes a call to be placed to a cellular phone of a person required to authorize the charge card transaction.

U.S. Pat. No. 7,792,301, issued to Bharadwaj et al., discloses in a storage system, multiple information units are individually associated with an access control policy (ACP) of multiple ACPs. Each respective information unit corresponds to a respective information unit encryption key (IUEK). The multiple information units are grouped into encryption zones based on their associated ACPs. In a described implementation, each ACP is associated with a zone root key (ZRK). In another described implementation, each IUEK corresponding to a given information unit is encrypted by an IUEK corresponding to an information unit at a most-proximate linked node of the storage system.

U.S. Pat. No. 5,799,086, issued to Sudia, discloses a cryptographic system with key escrow feature that uses a method for verifiably splitting user's private encryption keys into components and for sending those components to trusted agents chosen by the particular users is provided. The system uses public key certificate management, enforced by a chip device that also self-certifies. The methods for key escrow and receiving an escrow certificate are applied to register a trusted device with a trusted third party and to receive authorization from that party enabling the device to communicate with other trusted devices. The methods for key escrow also provide assurance that a trusted device will engage in electronic transactions in accordance with predetermined rules.

U.S. Pat. No. 7,178,027, issued to Faigle, discloses a system and method are provided in which a cryptographic key stored in a secure token such as a smart card can be copied to another smart card with high security and assurance with no intermediary being able to see what is being transferred. According to the invention, a host assisting in the transfer and a source smart card mutually authenticate themselves with each other. The host and a destination smart card also mutually authenticate themselves with each other. Then, the source card authenticates the destination card to ensure that the destination card is permitted to receive the cryptographic key of the source card. The source card then sends the cryptographic key to the destination card in a secure manner.

The inventions heretofore known suffer from a number of disadvantages which include but are not limited to failing to adequately protect keys; being difficult to operate, being easy to hack, requiring too much operating time to execute, being difficult to operate on a large scale, storing naked key data, storing relationships, providing too much access to system managers, employees, being vulnerable to man in the middle attacks, being vulnerable to long term surveillance, and the like and combinations thereof.

What is needed is a system and/or method that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available systems and methods. Accordingly, the present invention has been developed to provide systems and methods of protecting, storing and decrypting keys over a computerized network.

According to one embodiment of the invention, there is a method of decrypting sets of keys over a computerized network. The method may include the step of encrypting communications between an encryption escrow module and a keychain storage module according to an encryption schema wherein encryption algorithms change between at least one adjacent pair of communications, wherein at least one of the encryption keys include an electronic communication address of a sender.

The method may include requesting, according to the encryption schema, from an encryption escrow module a public key over a computerized network, the request coming from a keychain storage module. The method may include generating a biometric module associated with received biometric information that is associated with a particular keychain module stored by the keychain storage module.

The method of decrypting sets of keys may include the step of sending, according to the encryption schema, the biometric module to the encryption escrow module. The method may include the step of receiving, a decryption key indexed by the biometric module from an encryption escrow module. The method may include decrypting a keychain module associated with the biometric module using the decryption key.

The method may include the step of canceling an ongoing method of decrypting sets of keys over a computerized network if a specific predefined reply is not received before a predefined time-limit. The method may include the step of synchronizing an encryption schema with a remote encryption synchronization module over a network.

The method may include the step of storing a plurality of keychain objects within a keychain storage module, wherein each of the plurality of keychain objects is encrypted with a different encryption algorithm. The method may further include the step of encrypting an outgoing communication using an encryption key that is offset by the IP address of the sender.

According to one embodiment of the invention, there is a method of facilitating key decryption over a computerized network. The method may include the step of encrypting communications between an encryption escrow module and a keychain storage module according to an encryption schema wherein encryption algorithms change between at least one adjacent pair of communications, wherein at least one of the encryption keys include an electronic communication address of a sender.

The method may include the step of providing a public key, according to the encryption schema over a network, to a keychain storage module in response to receiving a request from a keychain storage module over a computerized network for a public key. The method may further include the step of receiving a biometric module associated with biometric information that is associated with a particular keychain module stored by the keychain storage module. The method may include hashing the biometric object.

The method of facilitating key decryption may include the step of using the hashed biometric module as an index value to retrieve stored decryption instructions from a library of different decryption instructions. The method may include the step of sending, according to the encryption schema, the retrieved decryption instructions. The method may include the step of canceling an ongoing method of decrypting sets of keys over a computerized network if a specific predefined reply is not received before a predefined time-limit. The method may include the step of synchronizing an encryption schema with a remote encryption synchronization module over a network.

According to one embodiment of the invention, there is a method of decrypting keys over a computerized network. The method may include the step of encrypting communications between an encryption escrow module and a keychain storage module according to an encryption schema wherein encryption algorithms change between at least one adjacent pair of communications, wherein at least one of the encryption keys include an electronic communication address of a sender. The method may include the step of requesting, according to the encryption schema, from an encryption escrow module a public key over a computerized network, the request coming from a keychain storage module. The method may include providing a public key, according to the encryption schema over a network, to a keychain storage module in response to receiving a request from a keychain storage module over a computerized network for a public key.

The method may include the step of generating a biometric module associated with received biometric information that is associated with a particular keychain module stored by the keychain storage module. The method may include the step of sending, according to the encryption schema, the biometric module to the encryption escrow module. The method may further include the step of hashing the biometric module. The method may include the step of using the hashed biometric module as an index value to retrieve stored decryption instructions from a library of different decryption instructions. The method may include the step of sending, according to the encryption schema, the retrieved decryption instructions. The method may include the step of receiving, a decryption key indexed by the biometric module from an encryption escrow module. The method may include the step of decrypting a keychain module associated with the biometric module using the decryption key.

The method of decrypting keys may include the step of canceling an ongoing method of decrypting sets of keys over a computerized network if a specific predefined reply is not received before a predefined time-limit. The method may include the step of synchronizing an encryption schema with a remote encryption synchronization module over a network. The electronic communication address may be an IP address. The method may further include storing a plurality of keychain objects within a keychain storage module, wherein each of the plurality of keychain objects is encrypted with a different encryption algorithm. The method may include the step of encrypting an outgoing communication using an encryption key that is offset by the IP address of the sender.

According to one embodiment of the invention, there is a method of storing sets of keys over a computerized network. The method may include the step of associating each of a plurality of keychain modules with a biometric module derived from a biometric indicator associated with a person, each keychain module including a plurality of keys. The method may include the step of hashing each biometric module, thereby creating a biometric hash for each biometric module. The method may further include the step of associating each biometric hash with a different encryption algorithm. The method may include the step of encrypting each of the plurality of keychain modules with an encryption algorithm matching the encryption algorithm associated with the biometric hash that is associated with each particular keychain module, thereby forming encrypted keychain modules.

The method of storing sets of keys may include the step of storing the different encryption algorithms in association with their associated biometric hash values in an encryption escrow module. The method may include the step of storing the encrypted keychain modules in a keychain storage module that is remote from the encryption escrow module and in communication with the encryption escrow module over a network.

According to one embodiment of the invention, there is a system for storing sets of keys using a computerized network. The system may include a keychain storage module, including a plurality of encrypted keychain modules, each keychain module associated with at least one of a plurality of user accounts and wherein the encrypted keychain modules are not all encrypted using the same encryption algorithm. The system may include an encryption escrow module, in communication with the keychain storage module but remote therefrom, including a library of encryption algorithms, the encryption algorithms being indexed according to a set of biometric hash values that are each associated with at least one of the plurality of user accounts.

The system for storing sets of keys may include an encryption synchronization module in communication with each of the encryption escrow module and the keychain storage module and including a predefined changing encryption pattern according to a script.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a network diagram of a system for protecting a set of encryption keys associated with a user account in an operational context according to one embodiment of the invention;

FIG. 2 illustrates keychain data communication and storage of a user account system in operational context according to one embodiment of the system and method;

FIG. 3 is a sequence diagram of a method of protecting a set of encryption keys associated with a user account according to one embodiment of the invention;

FIG. 4 is a module diagram of an encryption escrow module according to one embodiment of the invention;

FIG. 5 is a module diagram of a keychain storage module according to one embodiment of the invention;

FIG. 6 is a sequence diagram of a method of decrypting keys over a computerized network according to one embodiment of the invention; and

FIG. 7 is a sequence diagram of a method of storing keys over a computerized network according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module of programmable or executable code may, for instance, comprise one or more physical or logical blocks of computer instructions which may, for instance, be organized as an object, procedure, or function.

Nevertheless, the executables of an identified module need not be physically located together, but may comprise disparate instructions stored in different locations which, when joined logically together, comprise the module and achieve the stated purpose for the module. Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server, motherboard, network, chipset or other computing system including a processor for processing digital data; a memory device coupled to a processor for storing digital data; an input digitizer coupled to a processor for inputting digital data; an application program stored in a memory device and accessible by a processor for directing processing of digital data by the processor; a display device coupled to a processor and/or a memory device for displaying information derived from digital data processed by the processor; and a plurality of databases including memory device(s) and/or hardware/software driven logical data storage structure(s).

Various databases/memory devices described herein may include records associated with one or more functions, purposes, intended beneficiaries, benefits and the like of one or more modules as described herein or as one of ordinary skill in the art would recognize as appropriate and/or like data useful in the operation of the present invention.

As those skilled in the art will appreciate, any computers discussed herein may include an operating system, such as but not limited to: Andriod, iOS, BSD, IBM z/OS, Windows Phone, Windows CE, Palm OS, Windows Vista, NT, 95/98/2000, OS X, OS2; QNX, UNIX; GNU/Linux; Solaris; MacOS; and etc., as well as various conventional support software and drivers typically associated with computers. The computers may be in a home, industrial or business environment with access to a network. In an exemplary embodiment, access is through the Internet through a commercially-available web-browser software package, including but not limited to Internet Explorer, Google Chrome, Firefox, Opera, and Safari.

The present invention may be described herein in terms of functional block components, functions, options, screen shots, user interactions, optional selections, various processing steps, features, user interfaces, and the like. Each of such described herein may be one or more modules in exemplary embodiments of the invention even if not expressly named herein as being a module. It should be appreciated that such functional blocks and etc. may be realized by any number of hardware and/or software components configured to perform the specified functions. For example, the present invention may employ various integrated circuit components, e.g., memory elements, processing elements, logic elements, scripts, look-up tables, and the like, which may carry out a variety of functions under the control of one or more microprocessors or other control devices. Similarly, the software elements of the present invention may be implemented with any programming or scripting language such as but not limited to Eiffel, Haskell, C, C++, Java, Python, COBOL, Ruby, assembler, Groovy, PERL, Ada, Visual Basic, SQL Stored Procedures, AJAX, Bean Shell, and extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units, third party devices/systems and/or modules. Being “in communication” refers to any manner and/or way in which functional units and/or modules, such as, but not limited to, computers, networks, mobile devices, program blocks, chips, scripts, drivers, instruction sets, databases and other types of hardware and/or software, may be in communication with each other. Some non-limiting examples include communicating, sending, and/or receiving data and metadata via: a wired network, a wireless network, shared access databases, circuitry, phone lines, internet backbones, transponders, network cards, busses, satellite signals, electric signals, electrical and magnetic fields and/or pulses, and/or so forth.

As used herein, the term “network” includes any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using other protocols, including but not limited to IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

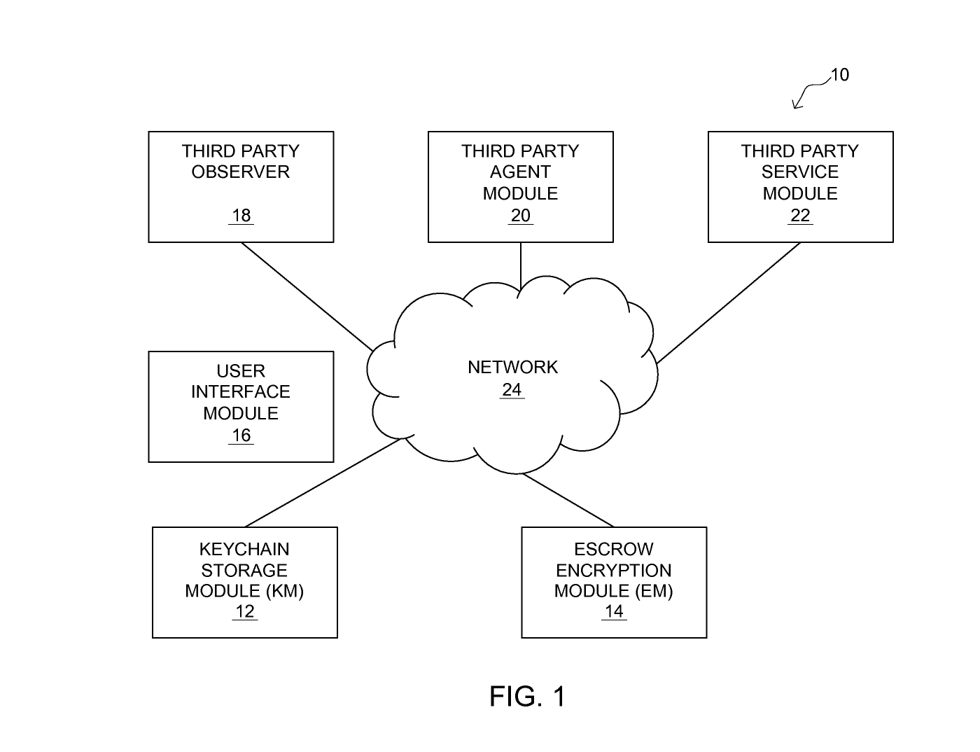

FIG. 1 is a network diagram of a system for protecting a set of encryption keys associated with a user account in an operational context according to one embodiment of the invention. There is shown a system for protecting a set of encryption keys 10 over a network 24 in communication with each of a keychain storage module (KM) 12, an encryption escrow module (EM) 14, a user interface module 16, a third party service module 22, a third party agent module 20, and a third party observer 18 (e.g. tools used by someone intending have unauthorized access/information/control/etc., such as but not limited to man in the middle, listener attack, hacking a server, etc.). Each of the illustrated systems/modules illustrated has a degree of communication, visibility and/or access to the others through the network. In operation of the system, a user, through the user interface module, is able to access data encrypted by a bank of encryption keys (keychain) within the keychain storage module and use one or more of those keys with a third party service module to obtain goods or services therefrom either directly or by using a third party agent module, all the while preventing a third party observer from obtaining usable access to the bank of keys, even if the third party observer is able to view all communications between such systems/modules and even if the third party observer is able to hack into one or more of the illustrated systems.

The illustrated keychain storage module 12 may simply automatically/electronically store and/or provide sets of keys (keychains) that may be associated with particular users, entities and/or accounts. A keychain storage module may be more complex, such as but not limited to including a computerized system for managing user accounts, generally, but not necessarily, through avatars that allow entities (people, companies, groups, etc.) to interact with each other, access information, do business, share data, make transactions and/or otherwise perform activities where privacy and/or security is desired/valuable. Such a system will generally store a plurality of encryption/decryption keys as a set of keys for each entity, wherein such keys are useful for various transactions and/or interactions with other entities/avatars. Accordingly, an entity may be enabled to access funds at a bank, enter a private encrypted chat, securely pass ownership of an item (virtual or otherwise) to another entity and/or perform a great variety of actions/tasks where privacy, validity, and/or security are of concern.

However, having such a set of keys associated with an entity creates a security risk, especially wherein a great number of entities have such keys stored in such a system. Accordingly, there is great incentive for third parties to attempt to crack such a system in order to obtain a great number of valuable keys. As described below, the keys and associated keychain storage module provide great benefit to their users, but could be used to great detriment by unauthorized third parties.

In one non-limiting embodiment, a keychain storage module 12 is a social networking e-commerce system where real people can create virtual personas that they can then use to interact with the real and virtual world. A persona can be owned and/or verified. An owned and verified persona is called a sovereign entity. A non-owned and non-verified persona may be referred to as a “ghost” or “ghost account.” In a non-limiting example there is an owned and non-verified persona that is never to be verified, such as, but not limited to a club, business, collective, etc. Verifying a persona involves another sovereign entity affirming the validity of one or more biometric readings and/or identification token(s) (government id, etc.) associated with a real person that are then, through verification and authentication by the Creator sovereign entity, associated with the ghost persona and then the ghost persona is owned by that real person whose biometric data is from then on tied to the sovereign entity. Sovereign entities can choose to create and/or become a part of one or more owned verified or non-verified personas. A persona has persona characteristics, such as but not limited to associated biometric data, inception date, creator, owner, and/or any demographic data associated with the owner. A persona can have one or more avatars, which are the “face” or “clothing” that the persona “wears” when it interacts with other entities. The avatar has avatar characteristics including but not limited to: name, appearance, demographic information, accumulated points, reputation, integrity, charisma, and etc, which may be calculated scores and or tracked and/or transferred among personas and/or avatars owned by a sovereign entity. Characteristics may be published, available only on request, or otherwise provided according to a particular predetermined protocol. As a non-limiting example, there may be a person using an active fully anonymous avatar that may receive a request if the persona associated with the avatar has a pacemaker and the avatar may provide that information only on request and/or may receive the information and act on it, such as but not limited to alerting the person through a device. Avatars may inherit persona characteristics. Personas may inherit owner characteristics. Some avatar characteristics are limited, required to be consistent with associated persona characteristics, or otherwise forced to be particular values or otherwise consistent across multiple and/or all avatars, such as but not limited to accumulated points, and/or integrity/reputation. Some avatar characteristics may be completely changable and/or user configurable, such as but not limited to name, associated images, and etc. Some avatar characteristics may be required to be verified by other sovereign entities and/or inherited from other entities, such as but not limited to recommendations, accreditations, and etc. Some avatar characteristics may be partially configurable and/or configurable only within predetermined and/or calculated ranges. Some avatar characteristics may be marked as private and/or null or otherwise not shown or available through a particular avatar. Interaction with other persona/avatars may be automated and/or regulated according to persona and/or avatar characteristics, such as not interacting with any avatar/persona having an integrity rating below a particular threshold. There may be avatar templates that may be forced in one or more modes of configuration, such as but not limited to general avatar, public avatar, professional avatar, and etc. Privacy is preserved by permitting sovereign entities to interact through avatars where determined characteristics are shown only as desired but because interaction critical characteristics (system unique identity, transaction information, etc.) are consistent and may be trusted, therefore the interactions may also be trusted. Other characteristics, such as real name, address, contact information, and etc. may be concealed or otherwise not associated with the transaction/interaction. Data may be stored in association with a persona and/or avatar and may be encrypted according to keys that may be associated with biometric data of the owner and/or other encryption techniques. A persona may have a half (or other fraction) key so that multiple personas may combine their keys to co-encrypt information that may be stored in association with a particular persona. As a non-limiting example, medical information may be co-encrypted so that only when the doctor and patient both consent and present their half-keys would particular data associated with a patient be accessible. Medical records may be stored twice, one set with the Doctor's Key, and one with the Patient's key. Points may be transacted between personas and/or avatars without revealing non-critical characteristics. There is a dispute resolution system wherein personas/avatars submit a dispute for resolution, pledge points to the solving thereof, provide evidence and argument in favor of their side and then non-involved parties may resolve the dispute and collect the pledged points while having access only to trusted characteristics that are associated with critical characteristics through the system. One part of this may include an editor who earns points by scrubbing identifying information from the evidence and arguments. Applications (business software, games, social networks, smartphone applications, and etc.) may be built on this platform and may interact therewith. The system may coordinate virtual and real-world interactions between entities/personas/avatars through devices such as but not limited to smartphones, RFID systems, home automation systems, inventory tracking systems, GPS devices, proximity sensors, and the like and combinations thereof. As a non-limiting example, a person may have an avatar that automatically activates in their smartphone when they are in a particular location as determined by the GPS of their smartphone. The automatically activated avatar may be a “consumer avatar” used for shopping. The avatar may, through a network contact or be contacted by a particular avatar of a retail store where the customer may be located at a particular moment and the two avatars may observe, judge, and/or automatically perform actions/interactions because of such.

The keychain storage module 12 may also include one or more scripts, objects, functions, libraries, protocol structures, protocol files, and the like and combinations thereof that may facilitate the operation of one or more of the functions, processes, procedures, steps, and/or etc. described herein. In particular, there may be a module configured to control operation of the keychain storage module in a manner consistent with one or more of the processes described herein.

The keychain storage module 12 may be associated with and/or incorporated into and/or incorporate one or more devices that can communicate over a network, including but not limited to tablets, personal computers, smartphones, terminals, kiosks, POS systems, servers and the like and combinations thereof that may include one or more network interface devices, wireless network communication devices, cellphone network communication devices, transponders, receivers, transceivers and the like and combinations thereof. Generally, a keychain storage module will, for security purposes, be very limited in its valid communications with other modules. As a non-limiting example, a keychain storage module may have only valid communications with an encryption escrow module and a system for managing data and/or allowing user interface with the same (if not already included as a module in the keychain storage module) and may otherwise be completely cut off from other devices and/or portions of a network. Such a system for managing data and/or for allowing user interface with the same may include and/or be in communication with third party applications that may request data from such a system, which may include but is not limited to documents, settings, images, applications, etc. Once requested, the system may interface with (or otherwise trigger) the keychain storage module wherein a key is needed to service the request. Accordingly, the user and the third party applications are, advantageously, not in direct communication with the keychain storage module.

The illustrated encryption escrow module 14 is configured to store encryption/decryption algorithms associated with particular biometric hash values and to encrypt and decrypt keys/keysets/keyrings/keychains on request in a manner that protects the same from unauthorized third parties. In particular, the encryption escrow module 14 may include a data storage device/module, an encryption/decryption module, a communication module, a clock module and any of such modules may include one or more devices (data storage device, processor, bus, network device, hub, router, and the like and combinations thereof) that facilitate operation of the same.

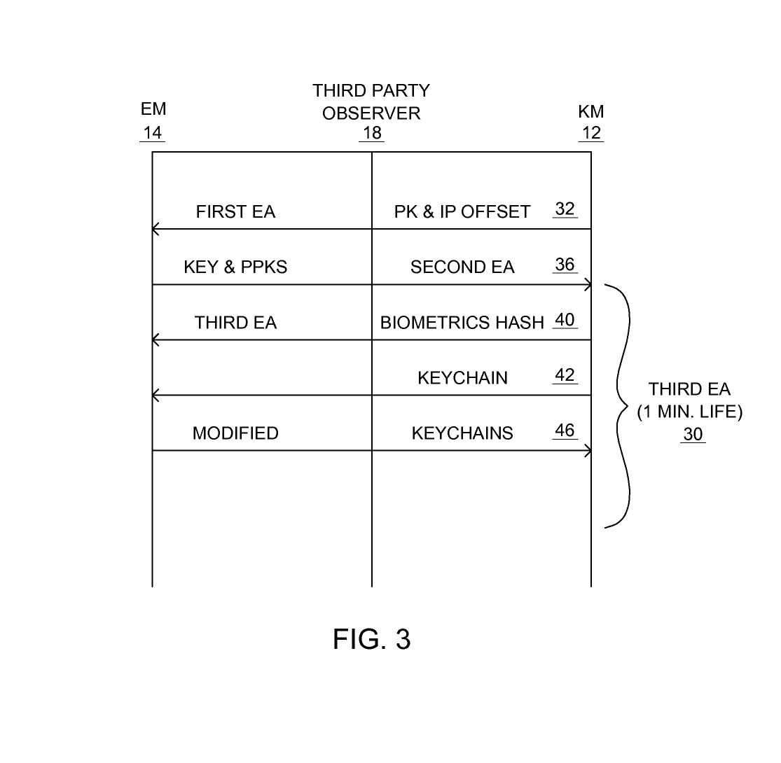

The encryption escrow module 14 may also include one or more scripts, objects, functions, libraries, protocol structures, protocol files, and the like and combinations thereof that may facilitate the operation of one or more of the functions, processes, procedures, steps, and/or etc. described herein. In particular, there may be a module configured to control operation of the encryption escrow module in a manner consistent with the process described in FIG. 3.

The encryption escrow module 14 may be associated with and/or incorporated into and/or incorporate one or more devices that can communicate over a network, including but not limited to tablets, personal computers, smartphones, terminals, kiosks, POS systems, servers and the like and combinations thereof that may include one or more network interface devices, wireless network communication devices, cellphone network communication devices, transponders, receivers, transceivers and the like and combinations thereof. Generally, an encryption escrow module will, for security purposes, be very limited in its valid communications with other modules. As a non-limiting example, an encryption escrow module may have only valid communications with a keychain storage module and may otherwise be completely cut off from other devices and/or portions of a network. In such a case, it may be that there is no system or module in direct communication with the encryption escrow module except for the keychain storage module and any systems/modules necessary to effectuate such direct communication.

The illustrated user interface module 16 is configured to permit a user to access the keychain storage module and request use of the EM. The user interface module 16 may include one or more user interface devices (non-limiting examples include: touch screen, keyboard, mouse, fingerprint readers, eye scanners, other biometric scanners of varying types, etc.) that may be associated with and/or incorporated into and/or incorporate one or more devices that can communicate over a network, including but not limited to tablets, personal computers, smartphones, terminals, kiosks, POS systems, servers and the like and combinations thereof that may include one or more network interface devices, wireless network communication devices, cellphone network communication devices, transponders, receivers, transceivers and the like and combinations thereof.

The illustrated third party service module 22 is configured to provide a third party service for users of the keychain storage module, including but not limited to any goods or services which may be offered, delivered, advertised, sold, executed, implemented, or otherwise associated in a meaningful way with an electronic/online/modular system, such as but not limited to the sale of goods/services (eBay, Amazon, etc.), banking, retail goods (Target, Walmart, etc.), insurance, financial products, professional services, and the like and combinations thereof.

The third party service module 22 may be associated with and/or incorporated into and/or incorporate one or more devices that can communicate over a network, including but not limited to tablets, personal computers, smartphones, terminals, kiosks, POS systems, servers and the like and combinations thereof that may include one or more network interface devices, wireless network communication devices, cellphone network communication devices, transponders, receivers, transceivers and the like and combinations thereof.

The illustrated third party agent module 20 is configured to facilitate the desires of the user of the keychain storage module and may act as a go-between between the keychain storage module or user and a third party service provider/module. Such modules may include a virtual assistant module, an anonymizer module, a collective purchasing module, a network, a group, a club, and the like and combinations thereof. In some instances, a third party agent module may need one or more (partial or full) keys from the keychain storage module in order to perform a desired function.

The third party agent module 20 may be associated with and/or incorporated into and/or incorporate one or more devices that can communicate over a network, including but not limited to tablets, personal computers, smartphones, terminals, kiosks, POS systems, servers and the like and combinations thereof that may include one or more network interface devices, wireless network communication devices, cellphone network communication devices, transponders, receivers, transceivers and the like and combinations thereof.

The illustrated third party observer 18 is present to illustrate that activities taken over a network are often subject to scrutiny by uninvolved parties that may have access to the network and to communications traveling thereon. The third party observer may be associated with and/or incorporated into and/or incorporate one or more devices that can communicate over a network, including but not limited to tablets, personal computers, smartphones, terminals, kiosks, POS systems, servers and the like and combinations thereof that may include one or more network interface devices, wireless network communication devices, cellphone network communication devices, transponders, receivers, transceivers and the like and combinations thereof.

In one non-limiting example, there is a system and/or method for protecting a set of encryption keys associated with a user account (user system or keychain storage module). In such a user system, there is a person/entity having one or more sets of associated biometric information stored in the system. Such information may be associated with an account for the person and such an account may include one or more avatars associated therewith. Further, such an account may include a virtual keychain/key-ring that may include a plurality of keys associated with devices/systems/files/etc. to which access and/or utilization is facilitated or enabled through use of one or more keys. Accordingly, it is beneficial to permit the person/entity access to the keychain. It is also desirable to prevent unauthorized access to the keychain.

However, for the keychain to be usable by the person/entity it must be stored in an accessible location, which then provides opportunity for those who desire unauthorized access. Where the system is breached and the keychain is discovered, the unauthorized user may have widespread access and may cause great harm to the person/entity. Where such a system includes many users, the harm may be multiplied greatly. Accordingly, it is desirable to provide access to the user, but not generate such a tempting target for unauthorized access. Similar harm may occur wherein unauthorized users gain access to biometric data (biometric object(s)) of one or more users.

In a non-limiting exemplary system/method configured to address such issues, a person may log in to a user system by giving/presenting their biometric information which allows the user system to retrieve an associated biometric object from a database. The biometric object is tied to (associated with) an encrypted keychain which can then be passed to an encryption/decryption system (encryption escrow module), which may even be an independent third party service, indexed off the biometric object (which may be a hash of the object instead of the actual naked data associated with the object). Accordingly, the user system is not storing naked key data, but instead associates encrypted key data with the biometric identifier for the person and the user system is required to communicate/transact with an encryption/decryption system (encryption escrow module) in order to obtain usable key(s).

In such a transaction, a first communication between the keychain storage module and encryption escrow module includes a biometric object (which the encryption escrow module hashes on receipt) and the IP address of the keychain storage module (generally as a natural course of the network communication protocol) along with a public key. However, in this example, the public key only works if the IP address of the keychain storage module is used as an offset. The encryption escrow module's reply may include one or more keys that may be used in subsequent communications and such keys may be identified as such. There may be one or more indexes into one or more databases associated with the EM. There may also be (incorporating the IP address of the keychain storage module) a public key and/or a modulus so that the public key infrastructure (PKI) is complete. It may be that the encryption escrow module may only permit such communications for a limited time, such as but not limited to by only holding the established PKI (or a portion thereof) valid for a time period (non-limiting example: a minute) and/or automatically dumping a process from memory after a period of time, whether complete or not.

Communications subsequent to establishing the PKI may then include passing data back and forth as needed for the keychain storage module to get the encrypted keychain decrypted by the encryption escrow module and receive an unencrypted copy of the key(s). Such may include, but is not limited to passing an encrypted keychain or a hash thereof, an encrypted encryption algorithm/process or a hash thereof, one or more encryption keys, one or more indexes, one or more index values, a biometric representation in digital form (e.g. a fingerprint/retinal scan/etc.), one or more hash algorithms and/or the like and combinations thereof.

In the present example, the keychain storage module 12 only stores encrypted keys and the encryption escrow module 14 only stores the encrypted decryption/encryption algorithms (neither stores naked key data in long term memory and naked key data is never transmitted between the encryption escrow module and keychain storage module in either direction). Accordingly, such a system is not vulnerable to having large scale key loss, as different keychains require different decryption techniques/algorithms/etc. and the communications protocol between the keychain storage module and encryption escrow module is robust, varies in the algorithm, key and key and thus is not subject to simple attacks such as man in the middle attacks, brute force attacks, Linear cryptanalysis, all plaintext attacks, birthday attacks, differential attacks, etc.

In one non-limiting embodiment, there is a system and/or method of protecting the communication of data between a server and client in such a way that the communication is not susceptible to ordinary circumvention, hacking, or cracking.

In another non-limiting embodiment, there is a system and/or method of protecting data from access by employees and IT workers.

In still another non-limiting embodiment, there is a system and/or method of encrypting and/or decrypting data such that it can only be accessed by supplying a valid combination of one or more of the following:
a. Biometrics
b. Pass codes
c. Usernames
d. Virtual addresses
e. GPS coordinates
f. Network card MAC addresses
g. Router addresses
h. Routing maps
i. Traceroute maps
j. Authentication codes
k. Etc

In a non-limiting embodiment, there is a system for storing sets of keys using a computerized network. The system includes a keychain storage module and an encryption escrow module, each connected to the other over a computerized network. The keychain storage module generally includes a plurality of encrypted keychain modules, each keychain module associated with at least one of a plurality of user accounts and wherein the encrypted keychain modules are not all encrypted using the same encryption algorithm. The encryption escrow module is in communication with the keychain storage module but remote therefrom. The encryption escrow module includes a library of encryption algorithms, the encryption algorithms being indexed according to a set of biometric hash values that are each associated with at least one of the plurality of user accounts. There may also be an encryption synchronization module in communication with each of the encryption escrow module and the keychain storage module. The encryption synchronization module may include a predefined changing encryption pattern according to a script and serve that to the encryption escrow module and the keychain storage module in a registered manner as needed for their ongoing communications.

In one non-limiting embodiment, there is a method of decrypting sets of keys over a computerized network. The method described below is described from the perspective of a keychain storage module or other similar facility wherein an encrypted key/keychain is stored and/or access to such a key/keychain is requested by a user associated with the key/keychain or other similar party, such as but not limited to an agent (real or virtual). The method includes encrypting communications between an encryption escrow module and a keychain storage module according to an encryption schema. The encryption scheme is such that encryption algorithms change between at least one adjacent pair of communications and/or at least one of the encryption keys include an electronic communication address of a sender (generally an IP address if communicating over the internet using standard protocols). The method also includes requesting a public key (generally according to the encryption schema) from an encryption escrow module over a computerized network. Generally, the request comes from a keychain storage module where encrypted keychain associated with various user accounts are stored. The method also includes generating a biometric module associated with received biometric information that is associated with a particular keychain module stored by the keychain storage module. The method also includes sending (generally according to the encryption schema) the biometric module to the encryption escrow module. The method also includes receiving a decryption key indexed by the biometric module from an encryption escrow module. Finally, the method includes decrypting a keychain module associated with the biometric module using the decryption key. The method may also include one or more of the following steps as well as others not described herein: canceling an ongoing method of decrypting sets of keys over a computerized network if a specific predefined reply is not received before a predefined time-limit; synchronizing an encryption schema with a remote encryption synchronization module over a network; storing a plurality of keychain objects within a keychain storage module, wherein each of the plurality of keychain objects is encrypted with a different encryption algorithm; and encrypting an outgoing communication using an encryption key that is offset by the IP address of the sender.

In another non-limiting embodiment, there is a method of facilitating key decryption over a computerized network. The method described below is described from the perspective of an encryption escrow module that is in communication with a keychain storage module over a network (generally the internet), wherein a library of indexed encryption/decryption algorithms may be stored. The method includes the step of encrypting communications between an encryption escrow module and a keychain storage module according to an encryption schema wherein encryption algorithms change between at least one adjacent pair of communications, wherein, generally, at least one of the encryption keys include an electronic communication address (generally an IP address) of a sender. The method also includes providing a public key (generally according to the encryption schema) to a keychain storage module in response to receiving a request from a keychain storage module for a public key. The method also includes receiving a biometric module associated with biometric information that is associated with a particular keychain module stored by the keychain storage module. The biometric module is then hashed by the encryption escrow module and used as an index value to retrieve a set of stored decryption instructions from a library of different decryption instructions. Finally, the method includes sending, according to the encryption schema, the retrieved decryption instructions so that they can be used to “unlock” the encrypted keychain(s) associated with the biometric module. The method may also include one or more of the steps of: canceling an ongoing method of decrypting sets of keys over a computerized network if a specific predefined reply is not received before a predefined time-limit; and/or synchronizing an encryption schema with a remote encryption synchronization module over a network.

Looking at an encryption escrow module and a keychain storage module as a single system (while still generally separated/connected by a network), there is a method of decrypting keys over a computerized network according to a non-limiting embodiment, generally including the following steps: encrypting communications between an encryption escrow module and a keychain storage module according to an encryption schema wherein encryption algorithms change between at least one adjacent pair of communications, wherein at least one of the encryption keys include an electronic communication address of a sender; requesting, according to the encryption schema, from an encryption escrow module a public key over a computerized network, the request coming from a keychain storage module; providing a public key, according to the encryption schema over a network, to a keychain storage module in response to receiving a request from a keychain storage module over a computerized network for a public key; generating a biometric module associated with received biometric information that is associated with a particular keychain module stored by the keychain storage module; sending, according to the encryption schema, the biometric module to the encryption escrow module; hashing the biometric module; using the hashed biometric module as an index value to retrieve a stored decryption instructions from a library of different decryption instructions; sending, according to the encryption schema, the retrieved decryption instructions; receiving, a decryption key indexed by the biometric module from an encryption escrow module; and decrypting a keychain module associated with the biometric module using the decryption key. The following steps may also be included: canceling an ongoing method of decrypting sets of keys over a computerized network if a specific predefined reply is not received before a predefined time-limit; synchronizing an encryption schema with a remote encryption synchronization module over a network; storing a plurality of keychain objects within a keychain storage module, wherein each of the plurality of keychain objects is encrypted with a different encryption algorithm; encrypting an outgoing communication using an encryption key that is offset by the IP address of the sender; canceling an ongoing method of decrypting sets of keys over a computerized network if a specific predefined reply is not received before a predefined time-limit; and synchronizing an encryption schema with a remote encryption synchronization module over a network.

In still another non-limiting embodiment, there is a method of storing sets of keys over a computerized network using a system including a keychain storage module and an encryption escrow module. The method includes the step of associating each of a plurality of keychain modules with a biometric module derived from a biometric indicator associated with a person, each keychain module including a plurality of keys. The method also includes the step of hashing each biometric module, thereby creating a biometric hash for each biometric module. The method also includes the step of associating each biometric hash with a different encryption algorithm. The method also includes the step of encrypting each of the plurality of keychain modules with an encryption algorithm matching the encryption algorithm associated with the biometric hash that is associated with each particular keychain module, thereby forming encrypted keychain modules. The method also includes the step of storing the different encryption algorithms in association with their associated biometric hash values in an encryption escrow module. Further, the method also includes the step of storing the encrypted keychain modules in a keychain storage module that is remote from the encryption escrow module and in communication with the encryption escrow module over a network.

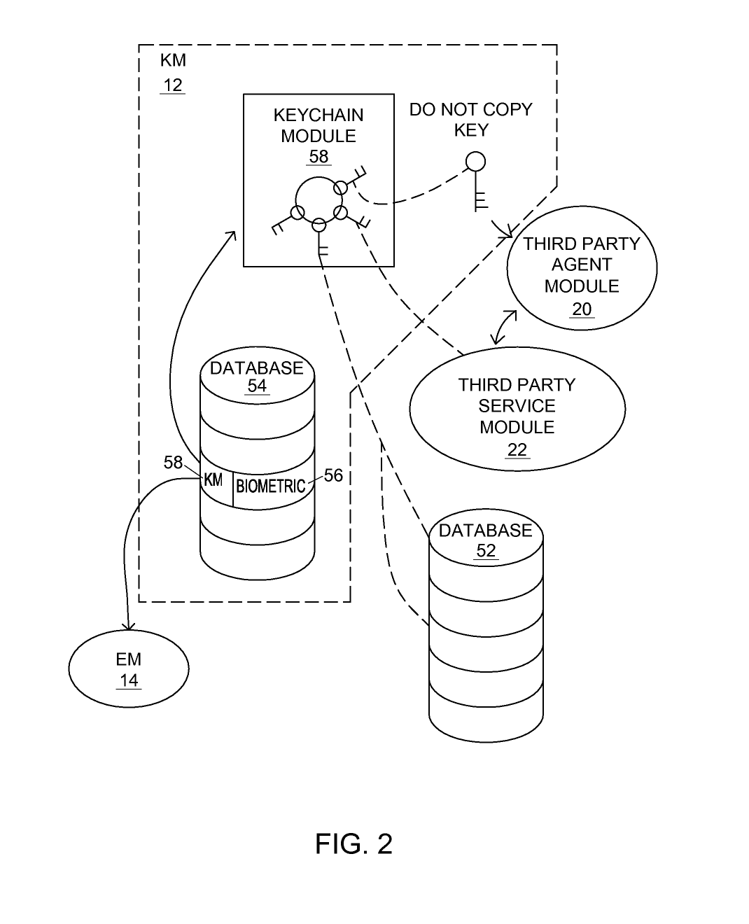

FIG. 2 illustrates keychain data communication and storage of a user account system in operational context according to one embodiment of the system. There is shown a database 54 within a KM 12 that includes a keychain module 58 having a plurality of keys. Such keys are associated with third parties but are unusable until decrypted through an Encryption Escrow System (EM) 14 and are stored and used in a manner that prevents Third Party Observers from easily obtaining the benefits thereof. In particular, there is shown an encrypted keychain module 58 stored within a database and associated with a set of biometric data 56. The encrypted keychain module 58 includes a plurality of keys that are usable in third party service modules 22, databases 52, and by third party agent modules 20, but only when decrypted by an associated EM 14.

The illustrated keychain module 58 is associated with data stored within a database within the KM 12. The keychain module 58 includes a plurality of encrypted keys associated with a particular user account through biometric data 56. The keys of the keychain module 58 may be used in a variety of manners by third party service modules 22 and/or third party agent modules 20 and may be used to access remote data, authorize/validate transactions, encrypt/decrypt data sets, and the like and combinations thereof. Keys may be public-private key sets (or just public keys), such as those in PKI (Public Key Infrastructure), passwords, encryption/decryption algorithms/scripts, biometric data of others (e.g. a wife storing the fingerprint of a deceased husband) and the like and combinations thereof.

The illustrated KM database 54 includes a plurality of stored keychain modules that are each associated with particular user accounts and/or particular biometric data. The database 54 includes a data storage device configured to store data thereon. The database is accessible by the KM 12 and thereby accessible to systems/modules outside the KM 12 as appropriate.

The illustrated EM system is in communication with the KM system 12 in a manner that permits the EM system 14 to provide decryption algorithms for specific keychain modules as needed.

The illustrated external database 52 and/or third party service module 22 are in communication with the KM 58 and may be accessible through use of one or more keys of a keychain module. The illustrated third party agent 20 may participate in the operation of one or more goods/services provided thereby and may have access to such through use of a key from the keychain module. Such a key may be denoted as a one-time use key, a “no copy” key that cannot be copied and/or stored in long-term memory and there may be one or more modules within the KM and/or external thereto that may enforce such restrictions.

FIG. 3 is a sequence diagram of a method of protecting a set of encryption keys associated with a user account according to one embodiment of the invention. There is shown an EM 14 and KM 12 each in communication with a third party observer 18 able to view each communication therebetween. The EM and KM communicate in a manner that permits functional collaboration in freeing an encrypted keychain to be used with third parties without the third party observer being able to use the keychain for its own purposes.

In particular, the method is illustrated with an understanding that there may be a third party observer that is able to view one or more, even each and every, illustrated interaction between the parties and may even have opportunity to manipulate and forward data passed between the parties in a manner intended by the third party to try and subvert or insert the third party into the communication stream in an interactive manner.

In the first illustrated communication between the KM and EM includes a public key exchange that is only readable when offset (or otherwise decrypted using) by the sender's IP address (First Encryption Algorithm “EA”) 32. Accordingly, the message cannot be properly interpreted by the EM unless the packet in which it arrives is addressed as being from the KM. Man in the middle attacks often include rerouting messages and establishing communications in a manner that the parties are no longer talking to each other but are (without awareness) sending all communications to a third party observer who is then forwarding on the communications, sometimes with modifications. However, wherein the utilization of the message received by the EM is dependent on being received from a valid and unchanged address, this form of deception is not useful. Even if a man in the middle is able to spoof a static address, transmitted data is still encrypted. In particular, further communications between the EM and KM would be disrupted because at some point one of the messages would be unusable to one of the systems and the other system would be unable to generate a valid and/or readable message. Accordingly, communications would abort or fail and the third party observer would be left with nothing meaningful to observe.

In reply, the EM provides a key encrypted with an encryption method and key that is variable and known to the requesting entity and may be generated by an encryption synchronization tool/module that may be remote from the other modules. In one non-limiting example, there is a key exchange according to a second encryption algorithm that may be based on data from the first interaction 36. In this manner the third party is not able to make substantial use of successful decryption of the first message, as a new encryption protocol/algorithm is used for the second communication, while the EM and KM are each aware of the encryption/decryption needed to handle each communication.

Using the response by the EM, the KM then (using a third encryption algorithm 30 that may be based on information provided by the reply by the EM) communicates a biometric object (which the EM hashes on receipt) associated with the biometric information provided by the user who desires to access or gain the benefit of their keys 40. This communication also includes the IP address of the KM (generally as a natural course of the network communication protocol) along with a public key. However, in this illustrated example, the public key only works if the IP address of the KM is used as an offset. The EM's reply may include one or more keys that may be used in subsequent communications and such keys may be identified as such. There may be one or more indexes into one or more databases associated with the EM. There may also be (offset by the EM IP address) a public key and/or a modulus so that the public key infrastructure (PKI) is complete 42.

In the illustrated example, the EM and/or KM only permits such communications for a limited time after the first, second, or third communication illustrated. Such may be accomplished, but is not limited to, by only holding the established PKI (or a portion thereof) valid for a time period (non-limiting example: a minute) and/or automatically dumping a process from memory after a period of time, whether complete or not. Accordingly, a third party observer has a very limited time in which to act on what it has already perceived and thus will have a much more difficult time penetrating the defenses of the EM and/or KM and their communications.

Communications subsequent to establishing the PKI may then include passing data back and forth as needed for the KM to get the encrypted keychain decrypted by the EM and receive a naked copy of the key(s) 46. Such may include, but is not limited to passing an encrypted keychain, a piece of an encrypted keychain, an encrypted encryption algorithm/process or, one or more encryption keys, one or more indexes, one or more index values, one or more and/or the like and/or hashes or combinations thereof.

Actual use of the encryption/decryption algorithm of the EM on the key/keychain may occur within the EM, KM, or a third party processing module.

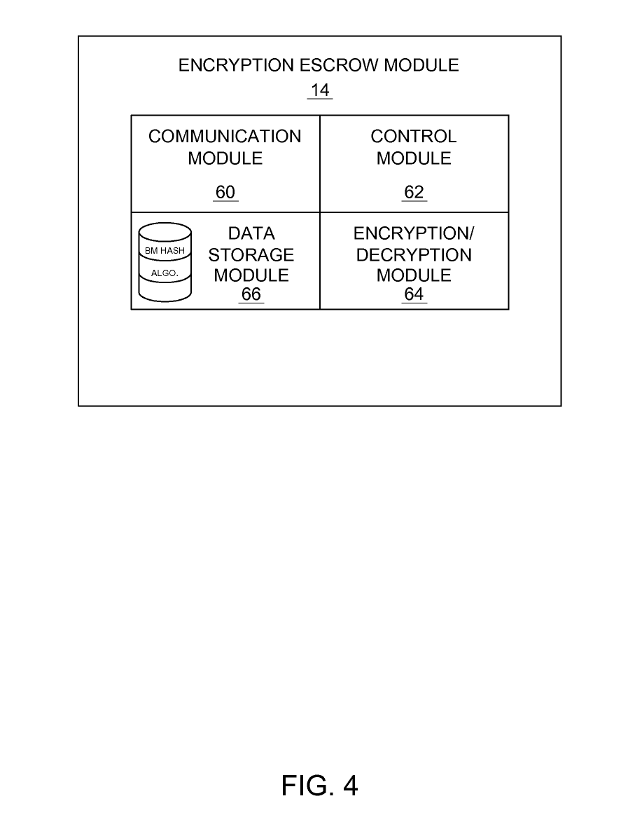

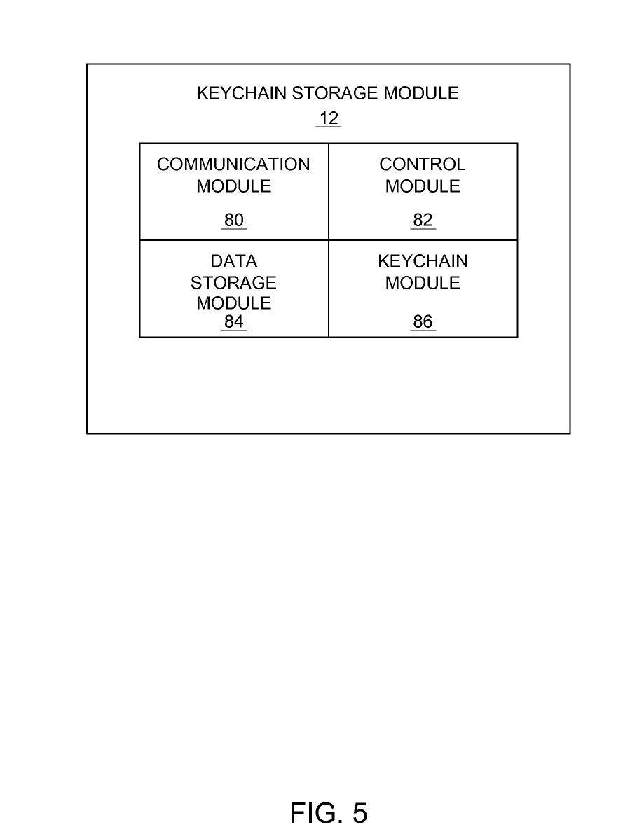

FIG. 4 is a module diagram of an encryption system (EM) according to one embodiment of the invention. There is shown an encryption escrow module 14 including a communication module 60, a control module 62, a data storage module 66, and an encryption/decryption module 64 that may each be in communication with one or more modules described herein such that the functions, features, benefits, options, and/or steps described herein may be performed/enhanced/facilitated thereby.

The illustrated communication module 60 is configured to provide communication capabilities to the modules and components of the encryption system. Such communication may be wireless, especially in regards to communications over a network, and/or may be wired and/or over a bus, such as may generally be found within a portable communication device. The communication module may also be configured to provide a secure method of communication over a network. Non-limiting examples of a communication module may be but not limited to: a communication module described in U.S. Pat. No. 5,307,463, issued to Hyatt et al.; or a communication module described in U.S. Pat. No. 6,133,886, issued to Fariello et al. which are incorporated for their supporting herein.

The illustrated control module 62, in communication with the communication module 60, is configured to provide operational controls and instructions to the modules and components of the encryption system. The control module 62 is in communication with the modules and components of the encryption module and is configured to provide operational instructions and commands thereto. Non-limiting examples of a control module may be a control module described in U.S. Pat. No. 5,430,836, issued to Wolf et al.; or a control module described in U.S. Pat. No. 6,243,635, issued to Swan et al. which are incorporated for their supporting teachings herein. A control module may include but is not limited to a processor, a state machine, a script, a decision tree, and the like.

The illustrated data storage module 66, in communication with the various modules and components of the encryption module 14, is configured to store data transferred therethrough. The data storage module 66 is configured to securely store encryption data along with authentication and authorization codes to access the encryption module. The data storage module is configured to store data from the encryption module, including data from the sender, from the receiver, from any third party associated with the sender or the receiver, etc. Data storage modules may be databases or data files, and the memory storage device may be hard drives or tapes. A non-limiting example of a data base is Filemaker Pro 11, manufactured by Filemaker Inc., 5261 Patrick Henry Dr., Santa Clara, Calif., 95054. Non-limiting examples of a data storage module may include: a HP Storage Works P2000 G3 Modular Smart Array System, manufactured by Hewlett-Packard Company, 3000 Hanover Street, Palo Alto, Calif., 94304, USA; or a Sony Pocket Bit USB Flash Drive, manufactured by Sony Corporation of America, 550 Madison Avenue, New York, N.Y., 10022; and/or MYSQL by Oracle Corporation of Redwood Shores, Calif.

The illustrated encryption/decryption module 64 may include one or more encryption/decryption tools, protocols, systems, and the like for use in the system, including but not limited to those needed to manage, control, determine, change, and/or process communications between the EM, KM, and any other third party modules described herein such that communications between the modules may be protected. Such an encryption/decryption module may include a plurality of encryption/decryption algorithms indexed by biometric hash data and/or the tools needed to operate such algorithms. Non-limiting examples of an encryption/decryption module may be a system as described in U.S. Pat. No. 4,281,216, issued to Hogg et al.; or a system as described in U.S. Pat. No. 6,931,551, issued to Weng et al.; or a system as described in U.S. Pat. No. 4,903,298, issued to Cline. The following encryption/validation/authorization systems which are incorporated herein by reference for their supporting teachings: U.S. Pat. No. 5,563,950; U.S. Pat. No. 5,778,072; U.S. Pat. No. 6,317,829; U.S. Pat. No. 6,084,969; U.S. Pat. No. 5,491,752; and U.S. Pat. No. 5,778,072.

FIG. 5 is a module diagram of a keychain storage module 12 (KM) according to one embodiment of the invention. There is shown a keychain storage module 12 including a communication module 80, a control module 82, a data storage module 84, and a keychain module 86 that may each be in communication with one or more modules described herein such that the functions, features, benefits, options, and/or steps described herein may be performed/enhanced/facilitated thereby.

The illustrated communication module 80 is configured to provide communication capabilities to the modules and components of the user account system. Such communication may be wireless, especially in regards to communications over a network, and/or may be wired and/or over a bus, such as may generally be found within a portable communication device. The communication module may also be configured to provide a secure method of communication over a network.

The illustrated control module 82, in communication with the communication module, is configured to provide operational controls and instructions to the modules and components of the user account system. The control module is in communication with the modules and components of the user account system and is configured to provide operational instructions and commands thereto.

The illustrated data storage module 84, in communication with the various modules and components of the user account system, is configured to store data transferred therethrough. The data storage module is configured to securely store user account data along with authentication and authorization codes to access the user account system. The data storage module is configured to store data from the user account, including profile, data, financial data, banking information, purchasing information, entity data, user account data, passwords, pass codes, etc.

The illustrated keychain module 86 is associated with data stored within a database within the KM. The keychain module includes a plurality of encrypted keys associated with a particular user account through biometric data. The keys of the keychain module may be used in a variety of manners by third party service modules and/or third party agent modules and may be used to access remote data, authorize/validate transactions, encrypt/decrypt data sets, and the like and combinations thereof. Keys may be public-private key sets (or just public keys), such as those in PKI (Public Key Infrastructure), passwords, encryption/decryption algorithms/scripts, biometric data of others (e.g. a wife storing the fingerprint of a deceased husband) and the like and combinations thereof. Examples of keychain modules may be found in U.S. Pat. No. 6,888,944 by Lotspiech; U.S. Pat. No. 6,650,753 by Lotspiech; and U.S. Pat. No. 4,607,137 by Jansen, which references are incorporated by reference herein for their supporting teachings.

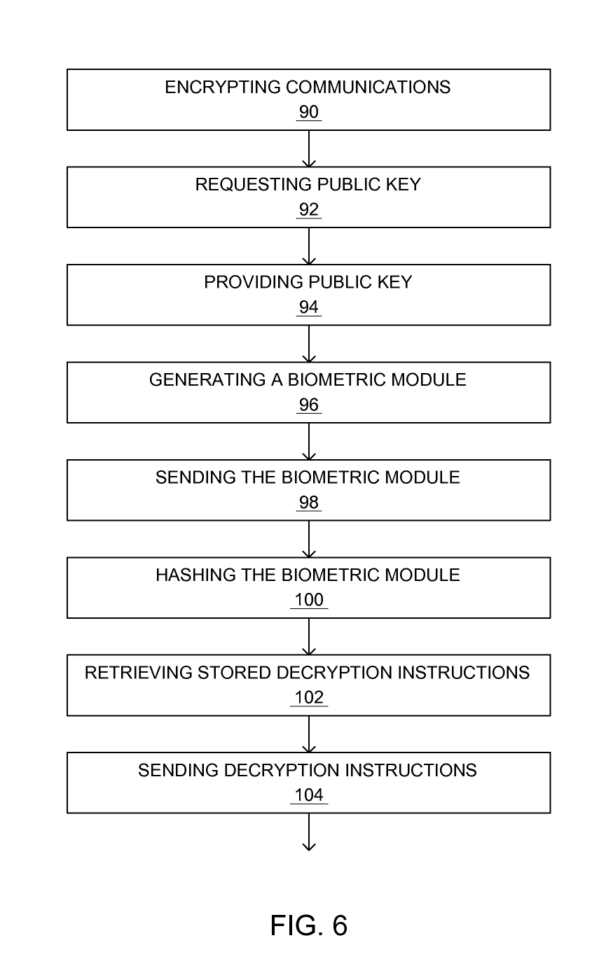

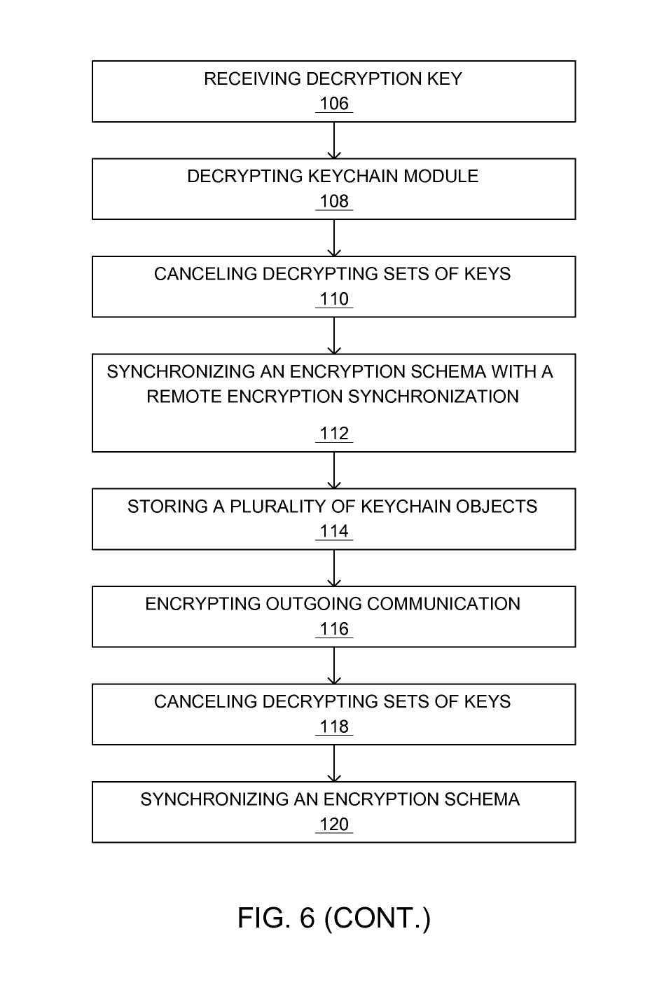

FIG. 6 is a sequence diagram of a method of decrypting keys over a computerized network according to one embodiment of the invention. The illustrated method includes an encryption escrow module communicating with a keychain storage module over a computerized network. Other, un-illustrated modules, may be included as appropriate.

The illustrated method begins with encrypting communications between an encryption escrow module and a keychain storage module according to an encryption schema wherein encryption algorithms change between at least one adjacent pair of communications, and wherein at least one of the encryption keys include an electronic communication address of a sender 90. While listed first, this step is generally present in the subsequent steps and is listed as being “first” in order to explain how communications are conducted between modules. Further, in order to accomplish such, the encryption schema and protocols must generally, at least partially, be established before communications commence.

Wherein encryption algorithms change from one set of communications (one or more messages) to another set of communications, efforts by a man in the middle that achieve results against one set of communications will not work against another. Accordingly, the man in the middle must continue to try and crack the communications. Changing encryption algorithms may include but is not limited to: changing from an asymmetric to a symmetric encryption scheme, swapping the order(s) of encryption functions used in the algorithm, changing which encryption functions are used, changing key(s), resetting or changing seed values, and the like and combinations thereof. The changing algorithm step is done automatically and each of the sender and receiver are aware of the change, either as a scripted change, or triggered by an event observable to both, or as a directed change from one module to another by providing a triggering and/or detailing instruction in regards to a change in algorithm.

Further, communications over a distributed network, such as but not limited to the internet, will generally flow, message by message through nodes of a network that provide the expected best transmission (usually speed). Accordingly, a man in the middle can usually not be certain to intercept all messages unless the stream is hijacked by replacing the sender's IP address with that of the man in the middle. Wherein the sender's IP address (or other electronic communications address of the sender) is actually part of the key, the man in the middle cannot replace the sender's IP without making the message unreadable to the recipient. Where the recipient receives a message that is unreadable, that will generally halt the process as failed and not allow the man in the middle to have further exposure to the same.

The illustrated method continues with requesting, according to the encryption schema, from an encryption escrow module a public key over a computerized network, the request coming from a keychain storage module 92. Generally, there is an initialization request to start communications between the modules. Since the keychain storage module is generally the source of the need to have the keychain decrypted, such a request will generally come from the keychain storage module. The request may be in many forms and may even be in a form that is not generally used to start a communication (e.g. may appear to be a database query), but so long as both the keychain storage module and the encryption escrow module recognize the request as being such a request and so long as the recipient of the request is able to reply as appropriate, the request is generally sufficient.

The illustrated method continues with providing a public key, according to the encryption schema over a network, to a keychain storage module in response to receiving a request from a keychain storage module over a computerized network for a public key 94. The provided key may be pre-generated, may be from a schedule of keys to be used, may be generated by the encryption escrow module, may be provided by a third party certification system or may otherwise be sourced. The public key (part of a PKI encryption system) is associated with a private key known to the encryption escrow module and thereby allows the keychain encryption module to communicate using the public key with the encryption escrow module.

The illustrated method continues with generating a biometric module associated with received biometric information that is associated with a particular keychain module stored by the keychain storage module 96. This may be accomplished by taking a reading from a biometric device, generally a same biometric device type that was used in an initial storage process (such as but not limited to the method of storing described herein). Such may include but is not limited to fingerprint scanners, DNA analysis devices, retinal pattern scanners, voice pattern analysis devices and the like and combinations thereof. Data that is not expected to be variable across readings is then extracted and then hashed in order to generate a hash that is highly likely to be identical to a hash similarly created during a storage process. That hash and/or any other associated information/programming/etc. is the biometric module. The biometric module may also include instructions for its use, instructions regarding subsequent communications and/or encryption schemes to be used, and the like and combinations thereof. Such a biometric module is effectively an indexing tool that may be used (see below) by the encryption escrow module to identify an encryption algorithm from a library of indexed encryption algorithms so that the same encryption algorithm may be used to both store and to decrypt a particular keychain associated with a particular human being to whom “belongs” the biometric object 96.

The illustrated method continues with sending, according to the encryption schema, the biometric module to the encryption escrow module 98; and hashing the biometric module 100. This step is generally encrypted, as described above, and may be encrypted using a different encryption algorithm from any of the previous communications described above.

The illustrated method continues with using the hashed biometric module as an index value to retrieve stored decryption instructions from a library of different decryption instructions 102. Index values matching or otherwise associated with hashed biometric modules (which may be hashed portions thereof, not necessarily hashing the entire module) are associated with specific encryption algorithms or schema by the escrow encryption module and therefore those same algorithms are searchable by the index values for later use in association with the same biometric module(s).

The illustrated method continues with sending (and receiving), according to the encryption schema, the retrieved decryption instructions 104. Accordingly, the appropriate decryption instructions (generally reversing the encryption instructions or otherwise applying an inverse function that undoes the encryption process) are provided to and received by the keychain storage module, which may make use of the same 106. Generally this communication is done over the network that connects the two modules and is done using the encryption schema outlined previously.

The illustrated method concludes with decrypting a keychain module associated with the biometric module using the decryption key 108. Once the keychain storage module has the appropriate encryption/decryption algorithm, it may use the same to decrypt the keychain/key associated therewith. The keychain storage module will generally retain the process in memory for a sufficient period of time to perform this function and then delete it and any copies that may have been made in the process 110. The naked (decrypted) key(s) will not have been transported over the network and even if a man in the middle or other security breach has occurred, the violator will not necessarily be able to match up the encryption algorithm with the right keychain and/or even know where to use the decrypted keys as a biometric module may be the only identifier of the account in the keychain storage module. The decrypted key(s) may be utilized by the owner of the account and/or by third parties, such as but not limited to third party agents, agent modules, service providers, and the like and combinations thereof.

The following steps may also be included as appropriate:

There may be a step of canceling an ongoing method of decrypting sets of keys over a computerized network if a specific predefined reply is not received before a predefined time-limit. As a non-limiting example, a module (encryption escrow module, keychain storage module, or other module described implicitly or explicitly herein) may, after a trigger, such as but not limited to sending a message to another module, begin a countdown timer or a script wherein, after a predetermined time, a process described herein is canceled, either directly or indirectly 110, 118. Accordingly, if a man in the middle or other security violation is taking a long time to try and process a message, generally in hopes of unlawfully decrypting the same, the process may be cancelled and must be restarted again with a new encryption schema. Processes may be cancelled by purging memory of the process, locking out further responses to communications in regards to a particular request or biometric module, alerting a counter-intrusion system or professional, and the like and combinations thereof.

There may be a step of synchronizing an encryption schema with a remote encryption synchronization module over a network 112. Such may include communicating with a remote encryption synchronization module configured to synchronize encryption schema between two communicating modules 120.

There may be a step of storing a plurality of keychain objects within a keychain storage module, wherein each of the plurality of keychain objects is encrypted with a different encryption algorithm 114. As a non-limiting example, there may be a plurality of user accounts, each associated with a keychain object, wherein each of the plurality of user accounts is indexed by a hashed biometric object. The hash function may be the same, but generally would not be the same, as a hash function used by an encryption escrow module. It may be that naked biometric objects are not stored in either system for any longer than needed to hash the same and/or communicate the same or a hashed version thereof to another module. Wherein they are different, a hacker of both the encryption escrow module library of indexed algorithms and the keychain storage module library of indexed encrypted keychain objects would not necessarily be able to match the appropriate algorithms with the appropriate encrypted keychain objects. The method includes the step of encrypting outgoing communications 116.

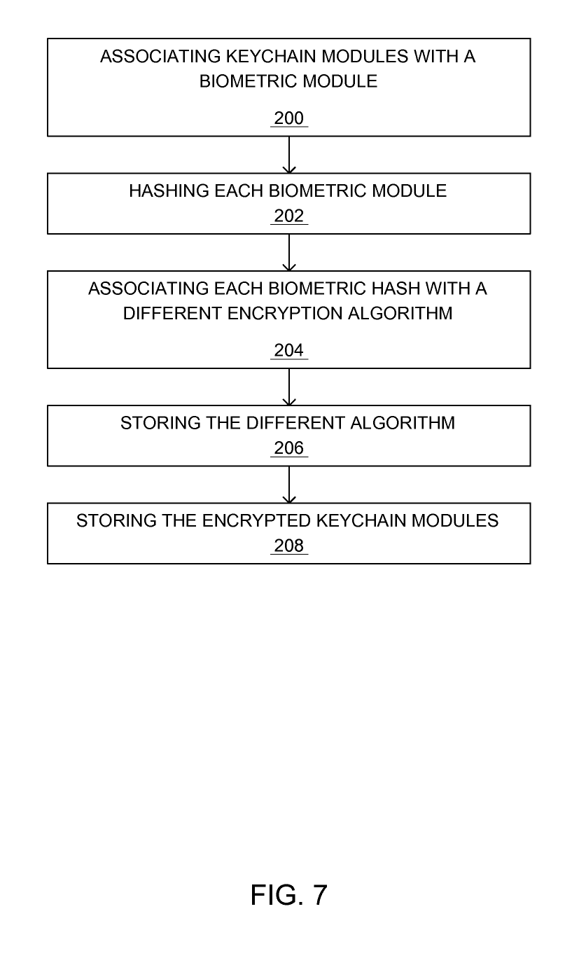

FIG. 7 is a sequence diagram of a method of storing keys over a computerized network according to one embodiment of the invention. The illustrated method includes an encryption escrow module communicating with a keychain storage module over a computerized network. Other, un-illustrated modules, may be included as appropriate.

The illustrated method begins with associating each of a plurality of keychain modules with a biometric module derived from a biometric indicator associated with a person, each keychain module including a plurality of keys 200. This step may be accomplished by associating the respective keychain modules and biometric modules directly as related records/entries in a database. There may be less direct methods, such as but not limited to hashing each biometric module and then associating the hashed value with the respective keychain module. Other methods of association, such as but not limited to using pointers, may be utilized.

The illustrated method continues with hashing each biometric module using a hash function, thereby creating a biometric hash (hash value, hash sum, checksum, etc.) for each biometric module 202. Hash functions automatically map data, usually of a variable length, to data (usually of a fixed length). Hash functions often do not map data on a one-to-one basis, thereby creating the possibility for two completely different sets of data to have identical hash values. Wherein a hash is used to index a user account in a keychain storage module, it will be generally desirable to not have identical hash values for different accounts. Wherein a hash is used to index an encryption algorithm in an encryption escrow module, there may be no problem with such a commonality of hash values, especially wherein there are sufficient possible encryption algorithms in the encryption escrow module to make brute force attacks sufficiently computationally expensive that they are not a meaningful option.

The illustrated method continues with associating each biometric hash with a different encryption algorithm 204. Such an association may be accomplished by having related records/entries in a database by storing algorithms or pointers to algorithms in memory addresses that correspond with the hash values possible according to the hash system used, and the like and combinations thereof.

The illustrated method continues with encrypting each of the plurality of keychain modules with an encryption algorithm matching the encryption algorithm associated with the biometric hash that is associated with each particular keychain module, thereby forming encrypted keychain modules. Accordingly the set of the plurality of keychain modules is encrypted with varying encryption algorithms, which with help from an encryption escrow module, may be undone. However, if an intruder into a system is able to obtain one of the encryption algorithms, the majority of the encrypted keychain modules are not un-lockable by that single encryption algorithm.

The illustrated method continues with storing the different encryption algorithms in association with their associated biometric hash values in an encryption escrow module 206. Such an association may be accomplished by having related records/entries in a database by storing algorithms or pointers to algorithms in memory addresses that correspond with the hash values possible according to the hash system used, and the like and combinations thereof.

The illustrated method concludes with storing the encrypted keychain modules in a keychain storage module that is remote from the encryption escrow module and in communication with the encryption escrow module over a network 208. Unless otherwise indicated, “remote” means at least on a different server having a different address within the network. Accordingly, a hacker trying to gain access to both a library of encryption algorithms and a set of user accounts (keychains) would have to hack two separate systems at two separate electronic addresses in order to do so. Such may also include being geographically remote, i.e. having different physical addresses, but is not geographically remote unless otherwise stated.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A method of decrypting sets of keys over a computerized network, comprising:
a) encrypting communications between an encryption escrow module and a keychain storage module according to an encryption schema wherein encryption algorithms change between at least one adjacent pair of communications, wherein at least one of the encryption keys include an electronic communication address of a sender;
b) requesting, according to the encryption schema, from an encryption escrow module a public key over a computerized network, the request coming from a keychain storage module;
c) generating a biometric module associated with received biometric information that is associated with a particular keychain module stored by the keychain storage module;
d) sending, according to the encryption schema, the biometric module to the encryption escrow module;
e) receiving, a decryption key indexed by the biometric module from an encryption escrow module; and
f) decrypting a keychain module associated with the biometric module using the decryption key.

2. The method of claim 1, further comprising the step of canceling an ongoing method of decrypting sets of keys over a computerized network if a specific predefined reply is not received before a predefined time-limit.

3. The method of claim 1, further comprising the step of synchronizing an encryption schema with a remote encryption synchronization module over a network.

4. The method of claim 1, wherein the electronic communication address is an IP address.

5. The method of claim 1, further comprising storing a plurality of keychain objects within a keychain storage module, wherein each of the plurality of keychain objects is encrypted with a different encryption algorithm.

6. The method of claim 1, further comprising the step of encrypting an outgoing communication using an encryption key that is offset by the IP address of the sender.

7. A method of facilitating key decryption over a computerized network, comprising:
a) encrypting communications between an encryption escrow module and a keychain storage module according to an encryption schema wherein encryption algorithms change between at least one adjacent pair of communications, wherein at least one of the encryption keys include an electronic communication address of a sender;
b) providing a public key, according to the encryption schema over a network, to a keychain storage module in response to receiving a request from a keychain storage module over a computerized network for a public key;
c) receiving a biometric module associated with biometric information that is associated with a particular keychain module stored by the keychain storage module;
d) hashing the biometric object;
e) using the hashed biometric module as an index value to retrieve a stored decryption instructions from a library of different decryption instructions; and
f) sending, according to the encryption schema, the retrieved decryption instructions.

8. The method of claim 7, further comprising the step of canceling an ongoing method of decrypting sets of keys over a computerized network if a specific predefined reply is not received before a predefined time-limit.

9. The method of claim 7, further comprising the step of synchronizing an encryption schema with a remote encryption synchronization module over a network.

10. A method of decrypting keys over a computerized network, comprising:
a) encrypting communications between an encryption escrow module and a keychain storage module according to an encryption schema wherein encryption algorithms change between at least one adjacent pair of communications, wherein at least one of the encryption keys include an electronic communication address of a sender;
b) requesting, according to the encryption schema, from an encryption escrow module a public key over a computerized network, the request coming from a keychain storage module;
c) providing a public key, according to the encryption schema over a network, to a keychain storage module in response to receiving a request from a keychain storage module over a computerized network for a public key;
d) generating a biometric module associated with received biometric information that is associated with a particular keychain module stored by the keychain storage module;
e) sending, according to the encryption schema, the biometric module to the encryption escrow module;
f) hashing the biometric module;
g) using the hashed biometric module as an index value to retrieve a stored decryption instructions from a library of different decryption instructions;
h) sending, according to the encryption schema, the retrieved decryption instructions;
i) receiving, a decryption key indexed by the biometric module from an encryption escrow module; and
j) decrypting a keychain module associated with the biometric module using the decryption key.

11. The method of claim 10, further comprising the step of canceling an ongoing method of decrypting sets of keys over a computerized network if a specific predefined reply is not received before a predefined time-limit.

12. The method of claim 10, further comprising the step of synchronizing an encryption schema with a remote encryption synchronization module over a network.

13. The method of claim 10, wherein the electronic communication address is an IP address.

14. The method of claim 10, further comprising storing a plurality of keychain objects within a keychain storage module, wherein each of the plurality of keychain objects is encrypted with a different encryption algorithm.

15. The method of claim 10, further comprising the step of encrypting an outgoing communication using an encryption key that is offset by the IP address of the sender.

16. A method of storing sets of keys over a computerized network, comprising:
a) associating each of a plurality of keychain modules with a biometric module derived from a biometric indicator associated with a person, each keychain module including a plurality of keys;
b) hashing each biometric module, thereby creating a biometric hash for each biometric module;
c) associating each biometric hash with a different encryption algorithm;
d) encrypting each of the plurality of keychain modules with an encryption algorithm matching the encryption algorithm associated with the biometric hash that is associated with each particular keychain module, thereby forming encrypted keychain modules;
e) storing the different encryption algorithms in association with their associated biometric hash values in an encryption escrow module;
f) storing the encrypted keychain modules in a keychain storage module that is remote from the encryption escrow module and in communication with the encryption escrow module over a network.

17. A system for storing sets of keys using a computerized network, comprising:
a) a keychain storage module, including a plurality of encrypted keychain modules, each keychain module associated with at least one of a plurality of user accounts and wherein the encrypted keychain modules are not all encrypted using the same encryption algorithm; and
b) an encryption escrow module, in communication with the keychain storage module but remote therefrom, including a library of encryption algorithms, the encryption algorithms being indexed according to a set of biometric hash values that are each associated with at least one of the plurality of user accounts.

18. The system of claim 17, further comprising an encryption synchronization module in communication with each of the encryption escrow module and the keychain storage module and including a predefined changing encryption pattern according to a script.
